(19) United States
(12) Patent Application Publication
(10) Pub. No.: US 2015/0233508 A1
(43) Pub. Date: Aug. 20, 2015

(54) METHOD AND SYSTEM FOR DELIVERING WATER USING A WATER-JET PROPELLED WATERCRAFT

(71) Applicant: Nelson Sceviour, Toronto (CA)

(72) Inventor: Nelson Sceviour, Toronto (CA)

(21) Appl. No.: 14/183,252

(22) Filed: Feb. 18, 2014

(51) Int. Cl. F16L 33/00; F16L 21/00

(52) U.S. Cl. CPC F16L 33/00; F16L 21/00

(57) ABSTRACT

A water outlet for a jet pump in a jet-powered watercraft comprises a first end for coupling to a jet expulsion end of the jet pump in fluid-tight communication, and a second end adapted to be coupled to a hose, whereby the watercraft jet pump is converted from a propulsion pump for propelling the watercraft to a fluid pump for pumping water through the hose. In some embodiments the watercraft jet outlet is adapted to connect to a hose. In other embodiments a separate adapter coupler is adapted to couple a hose to the existing jet outlet.

### FIELD OF THE INVENTION

This invention relates to water delivery apparatus. In particular, the invention relates to a method and system for delivering water in large volumes, particularly in remote areas.

### BACKGROUND OF THE INVENTION

One of the most widely used and effective tools for fighting house fires is the fire hydrant. Fire hydrants are capable of expelling very large volumes of water at high pressures, which can be used to douse a fire from a considerable distance. In urban areas fire hydrants are plentiful, and are located so that in general at least one fire hydrant is within reach of any residential or business structure via a standard fire hose. Considerable damage, and in some cases injury or even death, can be prevented by early dousing of a building fire with large volumes of water.

However, many remote areas, even those which have basic services such as electricity and water, do not have ready access to the high-volume water supply provided by fire hydrants. Accordingly, in remote towns and villages, and throughout many cottage areas, the most effective way to fight a house fire is by bringing in water trucks. This can be problematic, particularly in very remote rural areas where road access may be limited. Also, the number of water trucks in any given region is limited, so the availability of a water truck at the particular time that it is needed is not guaranteed.

In cottage areas in particular, water is generally plentiful since cottages tend to be built around lakes. However, a pump capable of supplying water at the high flow rates and pressures available from fire hydrants is not typically something that is stored by a cottager, and to bring a pump to a cottage that is on fire leads to the same problems of limited supply and difficult access that are experienced in the case of water trucks.

It would accordingly be advantageous to have equipment that is normally available in a remote area, or easily brought to a remote area, capable of pumping large amounts of water from a lake or other body of water, for example to douse a fire.

### BRIEF DESCRIPTION OF THE DRAWINGS

In drawings which illustrate by way of example only a preferred embodiment of the invention,

FIG. 1 is a schematic view of a water-jet propelled watercraft pumping water through a fire hose to douse a fire.

FIG. 2 is a plan view of an embodiment of a water-jet outlet of a water-jet propelled watercraft adapted for coupling to a fire hose coupler according to the invention.

FIG. 3 is a cross-section of the embodiment of FIG. 2 taken along the line 3-3.

FIG. 4 is a partly broken-away plan view of the embodiment of FIG. 2 showing the outlet coupled to a coupling end of a fire hose.

FIG. 5A is an elevation showing a coupler having one end adapted for coupling to a fire hose and the other end adapted for coupling to the water-jet outlet of a water-jet propelled watercraft.

FIG. 5B is an elevation of the coupler of FIG. 5A in a coupled condition.

FIG. 5C is an enlarged partial elevation of the coupler of FIG. 5A showing a locking mechanism for the coupling hooks.

### DETAILED DESCRIPTION OF THE INVENTION

The present invention provides a hose coupler for a water-jet propelled watercraft 10 that couples the jet's water outlet to a fire hose 2. The watercraft 10 can thus be driven to the scene of a fire and, while still in the lake or other body of water, a fire hose 2 can be coupled to the water-jet outlet of the watercraft to impel water through the fire hose 2 at high flow rates and pressures in order to douse the fire.

In some embodiments a coupler 60 of the invention serves as an adapter to couple a fire hose 2 to an existing water-jet outlet 30 of a water-jet propelled watercraft 10. In other embodiments the watercraft's water-jet outlet 30 is itself formed with a hose coupler end for coupling to a fire hose 2. In each case the coupling of a hose 2 to the water-jet outlet 30 effectively converts a water-jet propelled watercraft 10, on site, from a jet-propelled mobile craft that can reach a site near a body of water, for example the scene of the fire, relying solely on its own propulsion system, to a jet pump-based impeller apparatus which forces water through the fire hose 2 to fight a fire in a structure 1, or a forest fire, for example.

The invention will be described in the context of a popular personal watercraft, for example (without limitation) of the type described and illustrated in U.S. Pat. No. 5,062,815 issued Nov. 5, 1991 to Kobayashi, which is incorporated herein by reference. However, it will be appreciated that the principles of the invention can be applied to, and the advantages of the invention can be obtained from, any water-jet propelled watercraft 10.

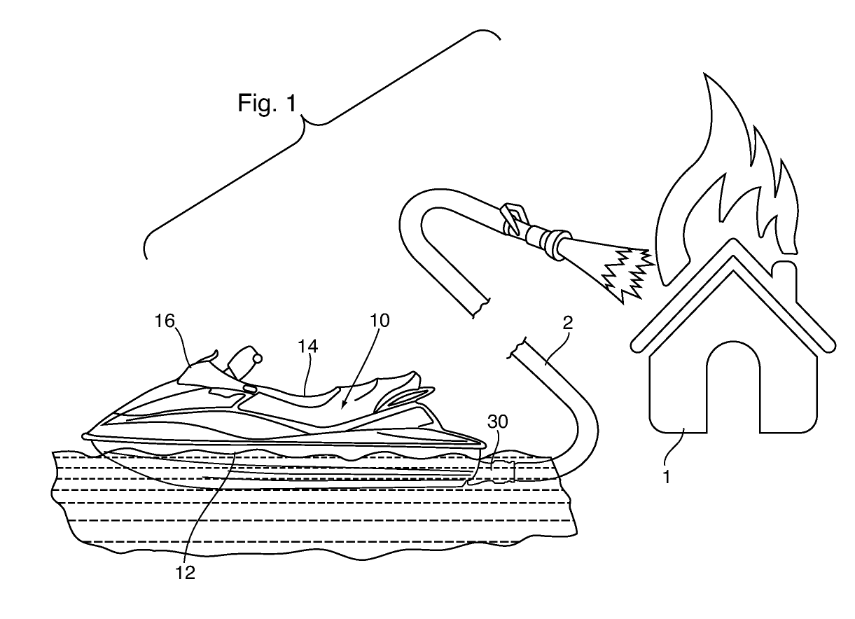

FIG. 1 illustrates a conventional water-jet propelled personal watercraft 10. The personal watercraft 10 has a hull 12, a seat 14 configured to support a driver and passengers, and a steering control mechanism, in the embodiment shown handlebars 16, for steering the watercraft 10. The watercraft 10 is propelled by a water-jet produced by a jet pump, which expels water at a high velocity via water-jet outlet 30 disposed at the rear of the watercraft 10. Typically the outlet 30 is pivotally mounted and actuated by the steering mechanism 16 to orient the water jet flow to the left or right and thus turn the watercraft 10.

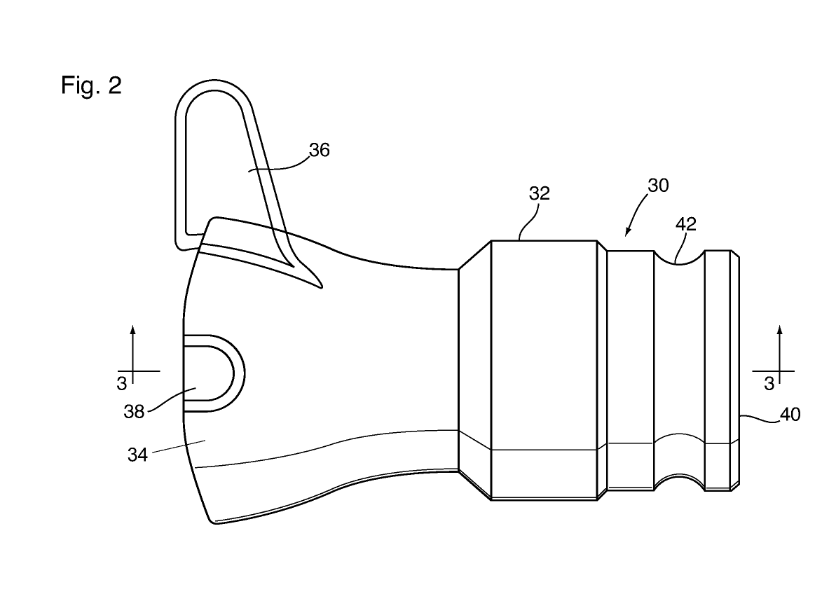

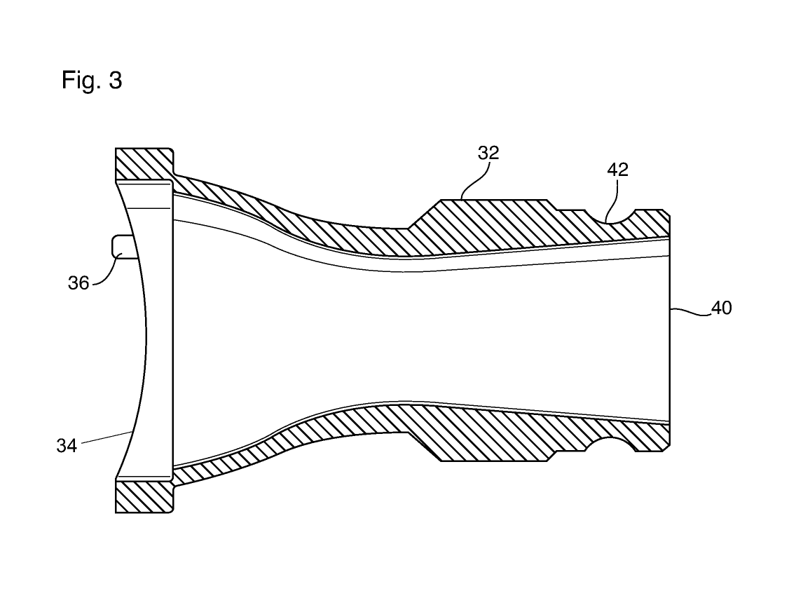

FIGS. 2 to 4 illustrate a water-jet outlet 30 for a water-jet propelled watercraft 10 adapted to couple to a fire hose 2 in accordance with the invention. The water-jet outlet 30 according to the invention comprises a body 32 having a first end 34 for coupling to the outflow end of the jet pump (not shown) that drives the watercraft 10. The first end 34 is thus configured as a conventional water-jet outlet would be, for coupling to the jet pump so as to be movable by the steering control mechanism 16 of the watercraft 10. A fixed fin 36 aligned generally parallel to the axis of the outlet 30 assists with steering the watercraft 10, as is well known. In some types of watercraft the jet outlet is also capable of vertical adjustment, for example pivotally mounted on bosses 38, to change the attitude of the watercraft 10 in the water.

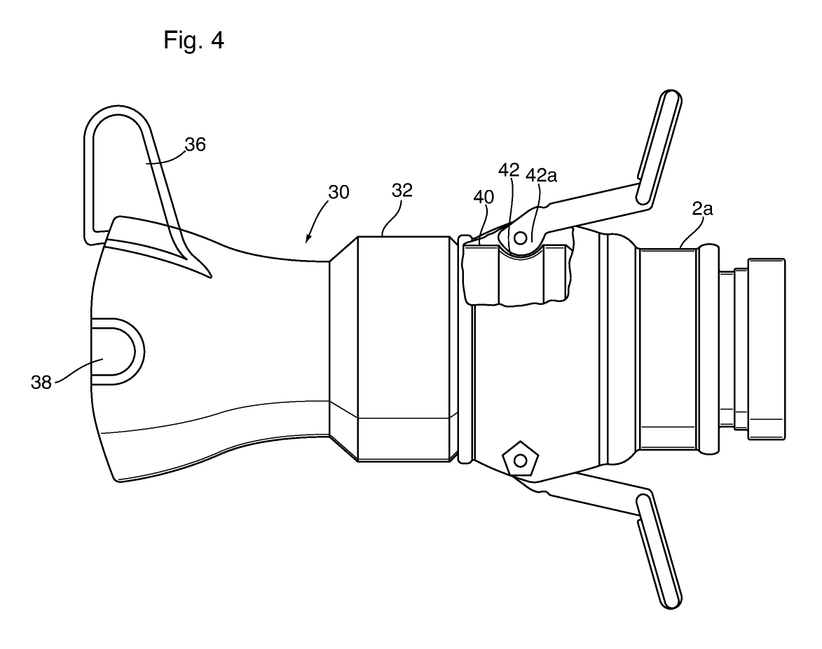

The other end 40 of the jet outlet 30 is the hose coupling end, adapted to couple to the coupling end of a fire hose 2. For example, the hose may couple to the hose coupling end 40 of the jet outlet 30 via a conventional cam and groove coupler, coupling the coupling end of the fire hose 2 to the jet outlet 30. As best seen in FIG. 4, the cam 42a of the hose coupler 2a is pivoted into position to lock the cam 42a into the groove 42 of the hose-coupling end 40 of the jet outlet 30 to retain the hose connection, as is well known. Any other suitable coupling mechanism may be utilized, bearing in mind the high pressures to which the hose coupling can be subjected, for example a bayonet connection or a “quick connect” type coupler commonly used to couple an air compressor to a pneumatic tool.

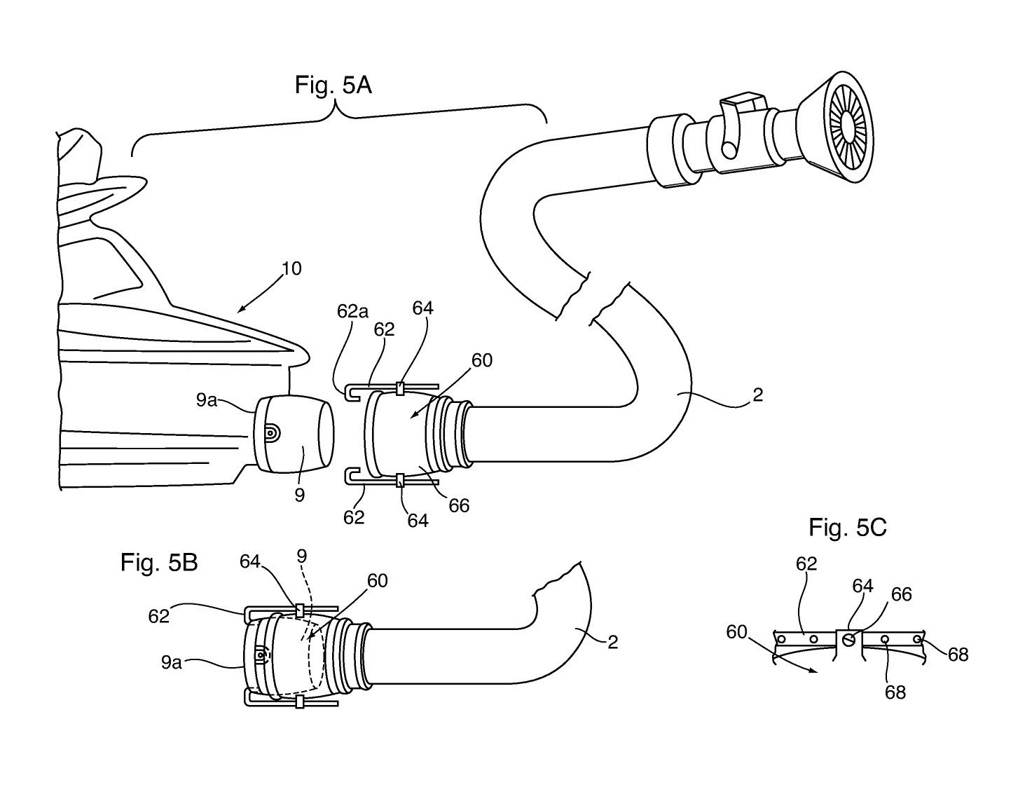

FIGS. 5A to 5C illustrate an embodiment of the invention in which an adapter 60 is provided to couple the hose 2 to an existing water-jet outlet 9 which has not been configured with any particular structure adapted to couple to the hose coupler 2a. In this embodiment the hose 2 is provided with a coupler 60 having a coupling mechanism for attachment to the water-jet outlet 9. In the embodiment shown the coupler 60 comprises a body 66 having an interior configured complementary to the exterior of the water-jet outlet 9 so as to overlap with an interference fit. A pair of “J”-shaped coupling hooks 62 are slidably mounted to the body 66, for example via clamping bights 64 which can be tightened using set screws 66 or in some other fashion to securely lock the coupler 60 to the water-jet outlet 9. In use the coupler 60 is manually pushed onto the water-jet outlet 9, and the hooked portions 62a of the coupling hooks 62 are hooked over the rear edge 9a of the water-jet outlet 9 and secured so as to clamp the coupler 60 to the water-jet outlet 9.

In this embodiment the coupling hooks 62 must be locked securely to the water-jet outlet 9, to ensure that the water pressure does not dislodge the coupler 60 from the water-jet outlet 9 during use. This can be accomplished in any number of ways, for example by providing holes 68 in the coupling hooks 62 into which the set screw 66 intrudes, or alternatively by providing threads on the coupling hooks 62 and a nut (not shown) which can be turned to tighten the coupling hooks 62 against the rear edge of the water-jet outlet 9.

In use, for example for dousing a fire at a lakefront cottage in a remote area, the watercraft 10 may already be located in or near the lake, for example stored on or beside a dock or other structure. If not, the water-jet propelled watercraft 10 can be driven to the site of the fire. With the jet pump of the watercraft 10 off, the coupling end 2a of a fire hose 2 is coupled to the water-jet outlet 30 in the manner described above, either directly where the water-jet outlet 30 has been configured to couple to a fire hose, as in the embodiments of FIGS. 2 to 4, or via a separate adapter coupler 60 such as that illustrated in FIG. 5 (without limitation). The watercraft 10 is then started, sucking water into its intake as though the watercraft 10 were in use, but pumping water out through the water-jet outlet 30 (directly or via a separate coupler 60), and thus through the fire hose 2, to douse the fire, as shown in FIG. 1.

It is beneficial to form the interior of the coupler 60 with smooth surfaces, which provide less resistance against the flow of water into the hose 2. The throttle of the watercraft 10 can be used to adjust the pressure of water egressing from the outlet 30 or coupler 60. In some embodiments of the adapter coupler 60 a relief valve (not shown) may be built into the coupler 60, providing an alternate way to adjust the pressure of water flowing through the hose 2, for example when the system is started up as the hose 2 is filling, and/or to relive the back-pressure against the jet pump during start-up.

Various embodiments of the present invention having been thus described in detail by way of example, it will be apparent to those skilled in the art that variations and modifications may be made without departing from the invention. For example, while the invention has been described in the context of delivering water to the site of a fire, the invention can be used to deliver high volumes of water at high pressure for any desired purpose and is not limited to firefighting.

1. An adapter for coupling a hose to an outlet of a jet pump in a jet-powered watercraft, comprising
a first end for coupling to a jet expulsion end of the jet pump in fluid-tight communication, and
a second end adapted to be coupled to a hose,
whereby the watercraft jet pump is converted from a propulsion pump for propelling the watercraft to a fluid pump for pumping water through the hose.

2. A water outlet for a jet pump in a jet-powered watercraft, comprising
a first end for coupling to a jet expulsion end of the jet pump in fluid-tight communication, and
a second end adapted to be coupled to a hose,
whereby the watercraft jet pump is converted from a propulsion pump for propelling the watercraft to a fluid pump for pumping water through the hose.
